(19) United States
(12) Patent Application Publication
(10) Pub. No.: US 2007/0092308 A1
(43) Pub. Date: Apr. 26, 2007

(54) Belt rotation device for image forming device

(76) Inventors: Hidetoshi Miyamoto, Osaka (JP); Kouji Uno, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,157

(22) Filed: Oct. 26, 2005

(51) Int. Cl. G03G 15/01

(52) U.S. Cl. 399/301

(57) ABSTRACT

As a portion to be detected of a belt 51, a protrusion 60 is provided on the width direction edge of the endless belt 51, and the tensile elastic modulus of the member forming the protrusion 60 is smaller than the tensile elastic modulus of the member forming the endless belt 51. Because the difference between the tensile elastic modulus of the protrusion material 60 and the tensile elastic modulus of the belt 51 is suitable, the protrusion material 60 can keep up with deformation of the belt 51 on the winding unit of the roller 54, so that a large stress does not arise in the surface direction on the adhesive interface between the belt 51 and protrusion material 60. Therefore, peeling of the protrusion material 60 by the driving of the belt 51 over a long period of time can be prevented.

### FIELD OF THE INVENTION

The present invention relates to a belt rotation device for an image forming device, and more particularly to a belt rotation device having provided therein a portion to be detected for detecting a belt member position.

### BACKGROUND INFORMATION

An electrophotographic image forming device has provided therein, in the vicinity of a photosensitive drum, charging means, exposure means, development means, transfer means, cleaning means, and other means. After the photosensitive drum is charged by charging means, exposure is performed by exposure means to form an electrostatic latent image on the photosensitive drum surface and this image is developed by development means. Thereafter, the developed toner image is transferred onto a transfer material by transfer means and fused by fuser means, and the transfer material on which an image has been formed is output to an output unit. Residual developer remaining on the photosensitive drum is cleaned by cleaning means.

Single drum type color image forming devices are configured such that, after an electrostatic latent image is formed on a photosensitive drum according to image information, development is sequentially performed by development units of, for example, magenta, yellow, cyan and black. The toner image sequentially formed by the development unit of each color is transferred to a transfer belt by first transfer means. The transfer belt is endlessly wound on a plurality of rollers, and the toner image on this transfer belt is transferred to a transfer material by second transfer means. Meanwhile, the transfer material is transported from a feed unit to a transfer position via a pair of resist rollers.

In such an image forming process, rippling or meandering may occur in the moving direction of a transfer belt wound endlessly on the plurality of rollers. Transfer belt meandering may cause image distortion, as in a square image becoming a parallelogram image and misalignment in color registration. Further, transfer belt rippling may cause image deformation, voids or the like.

To obtain an image where the images of each color are accurately superposed and having a high image quality without image distortion, it is necessary that neither meandering nor rippling occur on a transfer belt, and that the transfer belt be stably driven and transported. Further, in order to accurately superpose the images of each color and achieve high image quality, it is necessary that a transfer belt position be accurately known. For this reason, the specific position of a transfer belt is detected by a sensor.

To detect such a transfer belt position, there is a method where a position detection mark is provided using a stamp or an adhesive tape having light reflecting material on a transfer belt surface edge, and such mark is detected using an optical sensor, and there is a method where a position detection window hole is provided on a transfer belt edge and position is detected by a combination of this window hole and transmission type photoelectric sensor. Further, there is a method where a reinforcing member is attached to a guide rib joint on a belt end so that this reinforcing member itself protrudes from the belt edge, and is detected by an optical sensor.

When a body to be detected such as a stamp or light reflecting tape is attached by adhesion to a transfer belt surface, if there is too great a difference between the tensile elastic modulus of the transfer belt and that of the member forming the body to be detected, a difference will arise between the degree of change of perimeter length of the transfer belt and the degree of stretching of the body to be detected, causing a large stress to occur between the belt and the body to be detected, with the problem that through long-term use the body to be detected peels off. Further, a small image forming device may not have enough space to provide a position detection window hole on a transfer belt surface.

An object of the present invention is, using a simple configuration, to allow accurate detection of a transfer belt position over a long period of time.

### SUMMARY OF THE INVENTION

The belt rotation device for an image forming device relating to claim 1 comprises a driving roller, driven roller, endless belt, and portion to be detected. Here, the driving roller supports the endless belt, and causes the endless belt rotation to be driven by a drive unit. The driven roller is disposed opposite the driving roller, and supports the endless belt. The endless belt is stretched between the driving roller and driven roller, and while being driven by the driving roller so as to rotate, transports a loaded object such as, for example, a toner image. The portion to be detected is provided on the endless belt width direction edge, and is for detection of belt position.

A belt rotation device for an image forming device, for example, a transfer belt, is wound on a plurality of rollers and rotates, and to detect whether there is meandering, rippling or the like on the transfer belt, there is provided a portion to be detected consisting of a protruding member on the belt member. This portion to be detected is detected by detection means, and belt position is thereby detected. When the tensile elastic modulus of the member constituting the portion to be detected is larger than the tensile elastic modulus of the endless belt, the member constituting the portion to be detected cannot match belt deformation on roller winding unit, that is, the portion having a large belt curvature, and a large stress arises in the surface direction on the adhesive interface between the belt and the member to be detected, with the problem that the member to be detected may peel off through long-term driving of the belt.

With this invention, the portion to be detected on the belt is provided on the endless belt width direction edge, and the tensile elastic modulus of the member forming this portion to be detected is smaller than the tensile elastic modulus of the member forming the endless belt. Because the tensile elastic modulus of the member to be detected is smaller than the tensile elastic modulus of the endless belt member, the protruding member can keep up with belt deformation even on a portion having a large belt curvature, and large stress will not arise in the surface direction on the adhesive interface between the belt and the member to be detected; for this reason, the member to be detected will not peel off due to long-term driving of the belt.

The belt rotation device for an image forming device relating to claim 2 is a belt rotation device of claim 1, wherein the portion to be detected is a protrusion provided on the endless belt width direction edge so as to protrude in the width direction. Here, a protrusion is provided in the belt width direction, thereby simplifying the configuration of the portion to be detected and at the same time facilitating layout of an optical sensor or other detector.

The belt rotation device for an image forming device relating to claim 3 is a belt rotation device according to either one of claim 1 or claim 2, wherein the portion to be detected is preferably attached on the endless belt inner side.

The degree of stretching of the belt outer periphery portion is larger than the degree of stretching of the inner periphery thereof. Thus, if the portion to be detected is attached on the belt outer periphery, there may be peeling at the adhesive interface between the portion to be detected and the belt on the roller winding unit. Therefore, the portion to be detected is preferably attached on the endless belt inner side, thereby inhibiting the portion to be detected from peeling off the belt rotation device.

The belt rotation device for an image forming device relating to claim 4 is a belt rotation device according to any one of claims 1 through 3, wherein the thickness of the portion to be detected is preferably 200 μm or less. When the protruding member is attached on the belt inner periphery, if the portion to be detected is too thick, stable drive of the belt may be inhibited, and transfer displacement due to the thickness of the portion to be detected may occur, particularly on the roller winding unit. Thus, the thickness of the portion to be detected is preferably 200 μm or less, thereby suppressing the effect on stable drive of a belt by the thickness of the portion to be detected.

With the present invention thus configured, a member having a suitable tensile elastic modulus is selected as a portion to be detected, thereby allowing, with a simple configuration, accurate position detection over a long period of time.

### BRIEF DESCRIPTION OF THE DRAWINGS

FIG. 1 is a schematic vertical cross-sectional view of an image forming device employing the first embodiment of the present invention;

FIG. 2 is a perspective view of a transfer belt unit;

FIG. 3 is an enlarged view of a portion of a transfer belt being wound on a roller;

FIG. 4 is a cross-sectional view of a transfer belt unit; and

FIG. 5 is an enlarged view of a transfer belt unit having provided therein a portion to be detected.

### DETAILED DESCRIPTION OF THE PREFERRED EMBODIMENTS

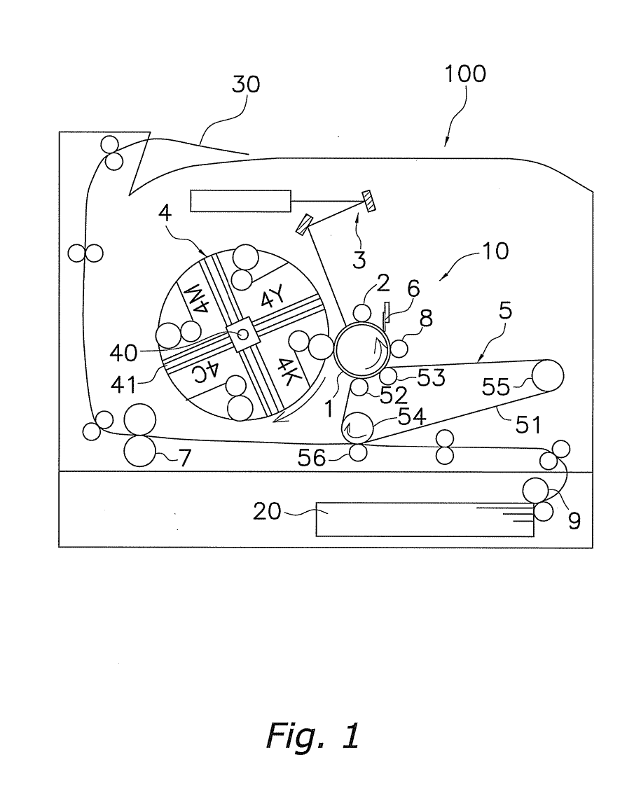

FIG. 1 shows an outline of the constitution of a color image forming device employing one embodiment of the present invention. A color image forming device 100 has an image forming unit 10 roughly in the center thereof The image forming unit 10 comprises a photosensitive drum 1, and, disposed around the photosensitive drum 1, a charging device 2, exposure device 3, development device 4, transfer device 5, cleaning device 6 and sliding roller 8. Further, a fuser device 7 is disposed downstream of the photosensitive drum 1 in the sheet transport direction. The image forming device has a feed unit 20 provided at a lower portion thereof, and a feed roller 9 disposed downstream of the feed unit 20 in the sheet feed direction.

An electrostatic latent image is formed on the surface of the photosensitive drum 1. For the present embodiment, an amorphous silicon photoconductor is used, comprising the following laminate structure laid down in the order given: a carrier injection prevention layer consisting of Si, H, B, O and the like on a conductive substrate, a carrier excitation/transport layer (photoconductive layer) consisting of Si, H and the like, and a surface protection layer consisting of SiC, H and the like are sequentially laminated. The charging device 2 is provided above the photosensitive drum 1, and causes the photosensitive drum 1 to be uniformly charged. The exposure device 3, based on an original document image read by an image data input unit 60 (not shown in the drawing), causes an electrostatic latent image to be formed on the photosensitive drum 1.

The development device 4 supplies toner to the surface of the photosensitive drum 1 on which an electrostatic latent image has been formed, thus forming a toner image. The development device 4 comprises a rotary rack 40, and a plurality of development apparatuses 4Y, 4M, 4C, 4K. The rotary rack 40 sequentially moves the plurality of development apparatuses 4Y, 4M, 4C, 4K to a development position opposite the photosensitive drum while rotating the same on a rotation axis 41 by rotation means (not shown in the drawing), thus causing development to be performed. Among the plurality of development apparatuses, the yellow development apparatus 4Y, magenta development apparatus 4M, cyan development apparatus 4C, and black development apparatus 4K are arranged and held in a circumferential direction of the rotary rack 40 in the order of 4Y, 4M, 4C, 4K, and adjacent development apparatuses are disposed so as to be spaced by roughly 90 degrees in the circumferential direction.

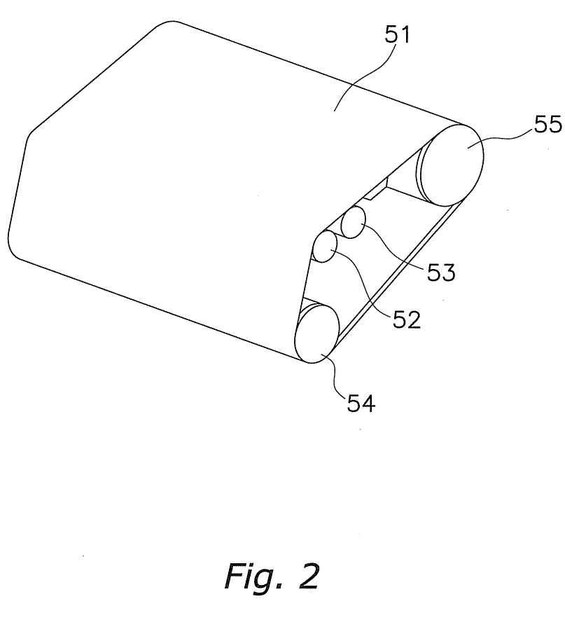

The transfer device 5, as shown in FIG. 2, transfers a toner image on the photosensitive drum 1 to a sheet, and comprises an intermediate transfer belt 51, first transfer rollers 52, 53, driving roller 54, driven roller 55, and second transfer roller 56. The intermediate transfer belt 51 is endlessly wound on the first transfer rollers 52, 53, driving roller 54 and driven roller 55. The intermediate transfer belt 51 is driven by the driving roller 54 rotated and driven by drive means such as a motor (not shown in the drawing), and serves as a transfer body onto which the toner image formed on the photosensitive drum 1 is transferred and on which the toner image is temporarily retained. The second transfer roller 56 is disposed at a position opposite the driving roller 54 on the outer periphery surface of the intermediate transfer belt 51, and performs second transfer of the toner image to the transfer material.

The cleaning device 6 cleans residual development and other adherents on the photosensitive drum 1, and consists of a cleaning blade. The cleaning blade is configured so that urethane rubber having hardness of 77° is pressed against the photosensitive drum at a linear pressure of 48 N/m. The fuser device 7 fuses the transferred toner image on sheet.

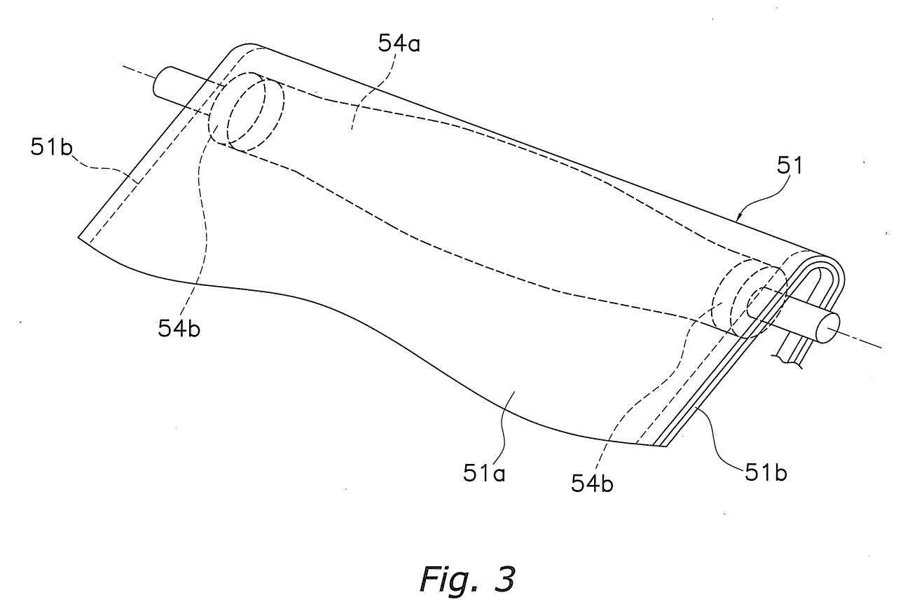

A detailed explanation will now be given regarding the constitutions of the transfer belt 51 and nearby elements of the color image forming device according to the present embodiment. In the present embodiment, as shown in FIG. 3, the transfer belt 51 has a belt body 51a consisting of a resin material such as polyester exhibiting optical transparency or a material exhibiting high transparency such as a polyamide resin, and a meandering prevention guide rib 51b having a predetermined width and fixed on both edges of the belt body 51a. In present embodiment a polyamide-imide resin belt having a thickness of 80 μm and tensile elastic modulus of 3500 MPa to which carbon black has been added is used. Further, to electrostatically transfer a toner image from the photosensitive drum 1 to the transfer belt 51, surface resistivity of the belt outer and inner peripheries is adjusted to 1 EΩ/□[sic]. Here, no particular limitations are placed with respect to the material of the belt body 51a provided it is formed of a material that does not inhibit detection of a member to be detected by an optical sensor.

Meanwhile, the driving roller 54 (for driving the transfer belt 51 at linear velocity of 180 mm/s and having an outer diameter of 20 m) on which the transfer belt 51 is stretched has a greater diameter portion 54a formed almost across its entire axial direction, and pulleys 54b formed on both axial ends of the driving roller 54 and having a diameter smaller than the greater diameter portion 54a. The ribs 51b on the both edges of the transfer belt 51 are engaged with the outer side in the axial direction of the pulleys 54b provided on both sides of the driving roller 54. The driven roller has an identical shape, and engages with the belt in an identical manner. Alternatively, a guide rib member and pulley member may be provided on one side of the belt.

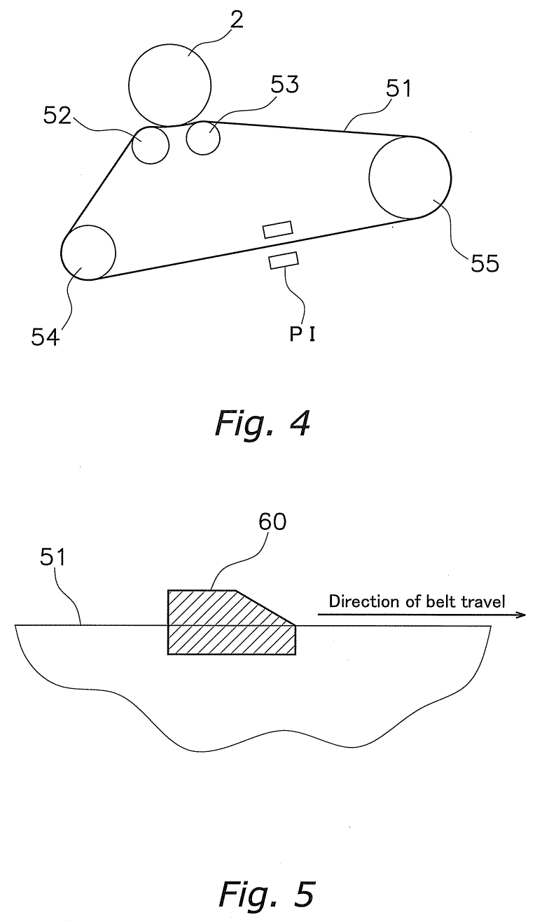

Further, as shown in FIG. 4, an optical sensor PI is disposed below the transfer belt 51. This optical sensor PI has a light emitting sensor and light receiving sensor, and is disposed at a position so that light can be radiated on the member to be detected 60. Light is radiated on the member to be detected 60 and the light reflected thereby is detected, enabling detection of the position of the member to be detected 60 and the presence of transfer belt meandering. The member to be detected 60, as shown in FIG. 5, is adhered by an adhesive agent or two-sided tape and fixed on the inner periphery surface of the belt body 51a (inner surface) and/or inner periphery of the rib 51b. Here, as the member to be detected 60, a polyvinylidene-fluoride resin material having a thickness of 80 μm and tensile elastic modulus of 2500 MPa is used. The present embodiment, as an adhesive agent, employs a two-sided tape produced by Nitto Denko, product number 5605.

Next, the operations of forming a color image will be explained. At time of image formation, after the photosensitive drum 1 has been charged by charging means 2, a rotary rack 40 rotates at the rotation axis 41 provided in the center thereof. The rotary rack 40 stops at the development position at which the development apparatus 4Y for the initial color, yellow, faces the photosensitive drum 1. In this state, exposure for yellow is performed by exposure means 3, and an electrostatic latent image for yellow is formed on the surface of the photosensitive drum 1. This electrostatic latent image is made into a toner image by the development apparatus 4Y, and the toner image formed on the surface of the photosensitive drum 1 is transferred to the transfer belt 51 by transfer bias applied to the first transfer rollers 52, 53. When a yellow toner image has been thus formed on the transfer belt 51, the rotary rack 40 rotates at the rotation axis 41 provided in the center thereof, thereby positioning the development apparatus 4M for magenta at the development position. The above operations are performed for magenta, cyan and black, thus forming a full-color toner image on the transfer belt 51.

As described above, the second transfer roller 56 is separated from the transfer belt 51 during the process of performing the first transfer of the toner image to the intermediate transfer belt 51. When a full-color toner image is to be formed on the transfer belt 51, the second transfer roller 56 is brought in direct contact with the transfer belt 51. At this time, the full-color toner image formed on the transfer belt 51 by the second transfer bias applied to the second transfer roller 56 is transferred to the transfer material transported from the feed unit 20 to the transfer position by a feed roller 9 or the like. The full-color toner image transferred to the transfer material is fused on the transfer material by heating/pressurizing using fuser means 7, and the transfer material is output to the sheet output unit 30.

In the image forming operations as described above, to obtain a high quality image such that the images of each color are synchronously superposed and the image has no distortion, it is necessary to detect whether there is any meandering of the transfer belt 51. Here, the member to be detected 60 is detected by the optical sensor PI, thereby detecting the position of the transfer belt 51 and the presence of meandering. More specifically, light is radiated on the member to be detected 60 attached to the transfer belt 51 and the light reflected therefrom is detected, enabling detection the position of the member to be detected 60 and the presence of meandering.

For the present embodiment, a polyamide-imide resin having a tensile elastic modulus of 3500 MPa is used as material for the belt 51. Further, a protrusion 60 is provided on the width direction edge of the endless belt 51, and a polyvinylidene-fluoride resin having a tensile elastic modulus of 2500 MPa is used as material for this protrusion. For this embodiment, the tensile elastic modulus of the member forming the protrusion 60 is 71.4% of the tensile elastic modulus of the member forming the endless belt 51; test results show that the number of rotations of the belt by the time the protrusion 60 peels off the transfer belt 51 is at least 600,000. That is, in this embodiment, because the difference between the tensile elastic modulus of the protrusion material 60 and the tensile elastic modulus of the belt 51 is suitable, the protrusion material 60 can keep up with the deformation of the belt 51 at such places as the winding unit of the roller 54, so that large stress does not arise in the surface direction on the adhesive interface between of the belt 51 and protrusion material 60. Therefore, peeling of the protrusion material 60 by long-term driving of the belt 51 can be prevented, and thus allowing accurate detection of the transfer belt position over a long period of time with a simple configuration. Therefore, because each color image is accurately superposed, a high image quality polychromatic image without misalignment in color registration can be easily achieved.

Table 1 shows test results of the present embodiment. In these tests, various materials and tensile elastic moduli for the transfer belt 51, and various materials and tensile elastic moduli for the protrusion 60 serving as a portion to be detected were used, and evaluation made of the number of rotations of the belt until the protrusion 60 peeled away from the transfer belt 51.

TABLE 1
Running evaluation test result

| | | Tensile | | Tensile | Tensile | | |
|---|---|---|---|---|---|---|---|
| | | elastic | | elastic | elastic | Number | |
| | | modulus | Protrusion | modulus | modulus | of | |
| | Belt material | (MPa) | material | (MPa) | ratio | rotations | Evaluation |
| Embodiment 1 | Polyamide-imide | 3500 | Polyvinylidene-fluoride | 2500 | 0.71 | 600K | ◯ |
| Embodiment 2 | Polyamide-imide | 3500 | Polyvinylidene-fluoride | 1950 | 0.56 | 600K | ◯ |
| Embodiment 3 | Polyamide-imide | 3000 | Polyvinylidene-fluoride | 1950 | 0.65 | 600K | ◯ |
| Embodiment 4 | Polyamide-imide | 3000 | Polyvinylidene-fluoride | 2500 | 0.83 | 120K | ◯ |
| Embodiment 5 | Polyamide-imide | 3500 | Polyvinylidene-fluoride | 3100 | 0.89 | 90K | ◯ |
| Comparative | Polyvinylidene-fluoride | 3500 | Polyamide-imide | 5000 | 1.43 | 60K | X |
| example 1 | | | | | | | |
| Comparative | Polyvinylidene-fluoride | 2300 | Polyamide-imide | 3100 | 1.35 | 70K | X |
| example 2 | | | | | | | |
| Comparative | Polyvinylidene-fluoride | 2300 | Polyamide-imide | 5000 | 2.17 | 40K | X |
| example 3 | | | | | | | |

As shown in the test results of the embodiments 1-5 shown in table 1, when the tensile elastic modulus of the protruding member forming the portion to be detected is 75% or less of the tensile elastic modulus of the member forming the endless belt, the number of rotations of the belt until the portion to be detected peels away from the belt is 600,000, enabling long-term accurate position detection. Further, when the tensile elastic modulus of the protruding member forming the portion to be detected is 90% or less of the tensile elastic modulus of the member forming the endless belt, the number of rotations of the belt until the portion to be detected peels away from the belt is 90,000 or more. On the other hand, when the tensile elastic modulus of the protruding member forming the portion to be detected is larger than the tensile elastic modulus of the member forming the endless belt, the number of rotations of the belt until the portion to be detected peels away from the belt is 80,000 or less.

As is clear from the test results, it is desirable that the tensile elastic modulus of the member forming the portion to be detected be 85% or less of the tensile elastic modulus of the member forming the endless belt, more preferably 75% or less. That is, selection of a protrusion 60 having a suitable tensile elastic modulus allows long-term accurate position detection with a simple configuration. In combining the member to be detected and a known material for an endless belt, it is preferable to select combinations so that the tensile elastic modulus of the member forming the portion to be detected be more than 50% of the tensile elastic modulus of the member forming the endless belt.

It goes without saying that the present invention is applicable to an image forming device having not only a transfer transport belt but also a transfer belt, intermediate transfer belt, photosensitive belt and other belt bodies.

What is claimed is:

1. A belt rotation device for an image forming device comprising:
a driving roller driven by a drive unit;
a driven roller disposed opposite the driving roller;
an endless belt stretched between the driving roller and driven roller; and
a portion to be detected for detecting the endless belt position, provided on the endless belt width direction edge;
wherein the tensile elastic modulus of the member forming the portion to be detected is smaller than the tensile elastic modulus of the member forming the endless belt.

2. A belt rotation device for an image forming device according to claim 1, wherein the portion to be detected is a protrusion provided on the width direction edge of the endless belt so as to protrude in the width direction.

3. A belt rotation device for an image forming device according to claim 1, wherein the portion to be detected is attached to the endless belt inner side.

4. A belt rotation device for an image forming device according to claim 1, wherein the thickness of the portion to be detected is 200 μm or less.
